(19) United States
(12) Patent Application Publication
(10) Pub. No.: US 2005/0082957 A1
(43) Pub. Date: Apr. 21, 2005

(54) Display panel with energy recovery system

(76) Inventors: Jurgen Jean Louis Hoppenbrouwers, Eindhoven (NL); Fransiscus Jacobus Vossen, Eindhoven (NL); Bart Andre Salters, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/506,290

(22) PCT Filed: Mar. 5, 2003
(86) PCT No.: PCT/IB03/00878

(30) Foreign Application Priority Data
Mar. 6, 2002 (EP) 020758603

(51) Int. Cl. H01J 1/00; H01K 1/00

(52) U.S. Cl. 313/3

(57) ABSTRACT

In a flatpanel display apparatus comprising plasma discharge cells (c) having sustain electrodes (Su) and scan electrodes (Sc), a drive circuit having a circuit (23) for providing data to the discharge cells (c) incorporating an energy recovery circuit and means for activating the energy recovery circuit is provided. The data supplied to the discharge cells (c) is arranged in subfields, and the means for activating the energy recovery circuit activate the energy recovery circuit only for a part of the total number of subfields.

The invention relates to a flat-panel display apparatus comprising plasma discharge cells having sustain electrodes and scan electrodes, a drive circuit having a circuit for providing data to the discharge cells, and an energy recovery circuit. The invention also relates to a method of recovering energy in a flat-panel display having sustain electrodes and scan electrodes and a drive circuit.

The invention applies particularly to AC plasma display panels (PDPs) used for personal computers, television sets, etc.

In a PDP, each row of the matrix is defined by two electrodes: a scan electrode and a sustain electrode. A cell is defined by one row (two electrodes) and a column electrode.

To show a picture on such a display, a sequence of three driving modes is applied for each sub-frame:
An erase mode, in which old data in the cells is ‘erased’, so the next (sub)frame can be loaded.
An addressing mode, in which the data of the (sub) frame to be shown is written into the cells.
A sustain mode, in which light (and thus the picture) is generated. All cells are sustained at the same time.

The data is written in subfields to generate gray levels.

Such display devices often comprise an energy recovery system for recovery of energy.

In such devices, energy recovery can be applied during sustaining (in the direction usually called the row direction) as well as during addressing (thus in the direction usually called the column direction) to reduce the power consumption of the panel. The advantages of energy recovery for the column drivers (i.e. parts of the driving circuit which drive the columns) are a decrease in the power consumption and electromagnetic radiation.

It is an object of the invention to provide a display device as described in the first paragraph in which energy recovery during addressing is improved.

To this end in a display device in accordance with the invention the data are arranged in subfields, and the means for activating the energy recovery circuit are adapted for activating the energy recovery circuit only for a part of the total number of subfields.

The invention is based on the insight that energy recovery for the column drivers is beneficial when the data on the columns changes value (1 to zero or zero to 1, or more in general active to non-active and vice-versa), whereas it is unfavorable when the data has to remain high. An apparent solution would be to apply energy recovery to those columns only, of which the data changes value. However, this is not possible because many if not all columns are connected to the same power cable and energy recovery system. Therefore, energy recovery can only be applied to a group of (or all) columns or to no column at all.

PDPs are conventionally driven by the so-called subfield driving scheme to create gray levels. In a device in accordance with the invention, energy recovery for the column drivers is applied only to a limited number of subfields. For some of the subfields, so the inventors have found, energy recovery may in fact cost energy. Activating the energy recovery circuit for such subfields is disadvantageous.

In preferred embodiments, the part of the sub fields during which in operation the energy recovery circuit is activated has on average a lower subfield weight than the rest of the sub-fields.

Subfields with a low weight will have a very low data correlation. Consequently, the data values will change often and energy recovery is desirable. On the other hand, subfields with a high weight will have a high data correlation. Thus, the data will remain high (or low) often and energy recovery is not desirable. By using this invention, energy recovery is only applied to part of the subfields (a part having relatively lower weights). Overall, this will result in a better power consumption and EMI reduction. Preferably, the subfields belonging to said part are all lower in weight or equal in weight than the subfields for which in operation the energy recovery circuit is activated.

In an embodiment data electrodes are present being positioned in a zigzag configuration.

Such a configuration is especially advantageous if a distributed subfield scheme is applied which uses different gray level schemes for adjacent pixels. By positioning data electrodes in a zigzag configuration, whereby the data electrodes are coupled to pixels in subsequent rows, which are driven with a same gray level scheme, a better correlation of the subsequent data on such data electrodes is obtained. So, again selective energy recovery may be used for the subfields with a low weight.

In a preferred embodiment, the display apparatus comprises a discriminator having means for choosing, on the basis of the data to be displayed, the part of the subfields during which the energy recovery circuit is activated.

These and other objects of the invention are apparent from and will be elucidated with reference to the embodiments described hereinafter.

### BRIEF DESCRIPTION OF THE DRAWINGS

In the drawings:

FIG. 1 is a cross-sectional view of a pixel of a PDP device,

FIG. 2 schematically illustrates a circuit for driving a PDP of a surface-discharge type in a subfield mode as known from the prior-art,

FIG. 3 illustrates voltage waveforms between scan electrodes and sustain electrodes of the known PDP,

FIG. 4 further illustrates the layout of pixels in a plasma display panel,

FIGS. 5 to 6e illustrate an energy recovery scheme for recovering energy in the sustain phase,

FIGS. 7 to 8d illustrate an energy recovery scheme for recovering energy in the address phase,

FIG. 9 shows in a graphical form the energy recovery in the address phase as a function of subfield number for a video image,

FIG. 10 shows in a graphical form the energy recovery in the address phase as a function of subfield number for a data-graphics image,

FIG. 11 shows an example of a duplicated subfield scheme,

FIG. 12 shows how alternate schemes of gray level realization may be applied to adjacent pixels,

FIG. 13 shows data electrodes having a zig-zag configuration, and

FIG. 14 shows a zig-zag configuration with pixels having different cells for emitting different colors.

The Figs. are schematic and not drawn on scale. Generally, identical components are denoted by the same reference numerals in the Figs.

### DETAILED DESCRIPTION OF PREFERRED EMBODIMENTS

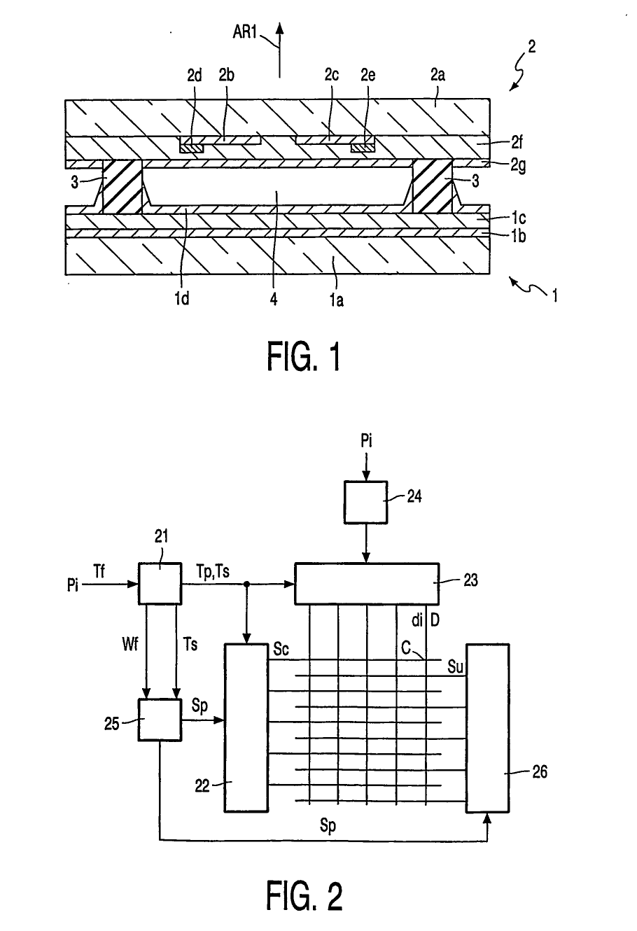

The prior-art pixel shown in FIG. 1 produces an image in the following steps.

FIG. 1 illustrates the structure of a pixel (discharge cell). The pixel comprises a back substrate structure 1 and a front structure 2, and a partition wall 3 which spaces the back structure 1 from the front structure 2. Discharge gas 4 such as helium, neon, xenon, or a gaseous mixture thereof fills the space between the back structure 1 and the front structure 2. The discharge gas generates ultraviolet light during discharging. The back structure 1 comprises a transparent glass plate 1a on which a data electrode 1b is formed. The data electrode 1b is covered with a dielectric layer 1c, and a phosphor layer 1d is laminated on the dielectric layer 1c. The ultraviolet light is radiated onto the phosphor layer 1d, and the phosphor layer 1d converts the ultraviolet light into visible light. The visible light is indicated by arrow AR1. The front substrate 2 comprises a transparent glass plate 2a, on which a scan electrode 2b, 2d and a sustain electrode 2c, 2e are formed. The scan electrode 2b, 2d and the sustain electrode 2c, 2e extend perpendicularly to the data electrode 1b. These electrodes 2b, 2c, 2d, and 2e are covered with a dielectric layer 2f, and the dielectric layer 2f may be covered by a protective layer 2g. The protective layer 2g is formed, for example, from magnesium oxide and protects the dielectric layer 2f from the discharge. An initial potential larger than the discharging threshold is applied between a scan electrode 2b and a data electrode 1b. Discharging takes place between them. Positive charge and negative charge are attracted towards the dielectric layers 2f and 1c, respectively, across the scan electrode 2b and the data electrode 1b and are accumulated thereon as wall charges. The wall charges produce potential barriers and gradually decrease the effective potential. Therefore, the discharge is stopped after some time. Thereafter, a sustain pulse is applied between the scan electrodes 2b and the sustain electrodes 2c, which pulse is identical in polarity to the wall potential. Therefore, the wall potential is superimposed on the sustain pulse. The superimposition causes the effective potential to exceed the discharging threshold, and a discharge is initiated. Thus, while the sustain pulse is being applied between the scan electrodes 2b and the sustain electrodes 2c, the sustain discharge is initiated and continued. This is the memory function of the device. This process occurs in all pixels at the same time.

When an erase pulse is applied between the scan electrodes 2b and the sustain electrodes 2c, the wall potential is cancelled, and the sustain discharge is stopped. The erase pulse has a wide pulse width.

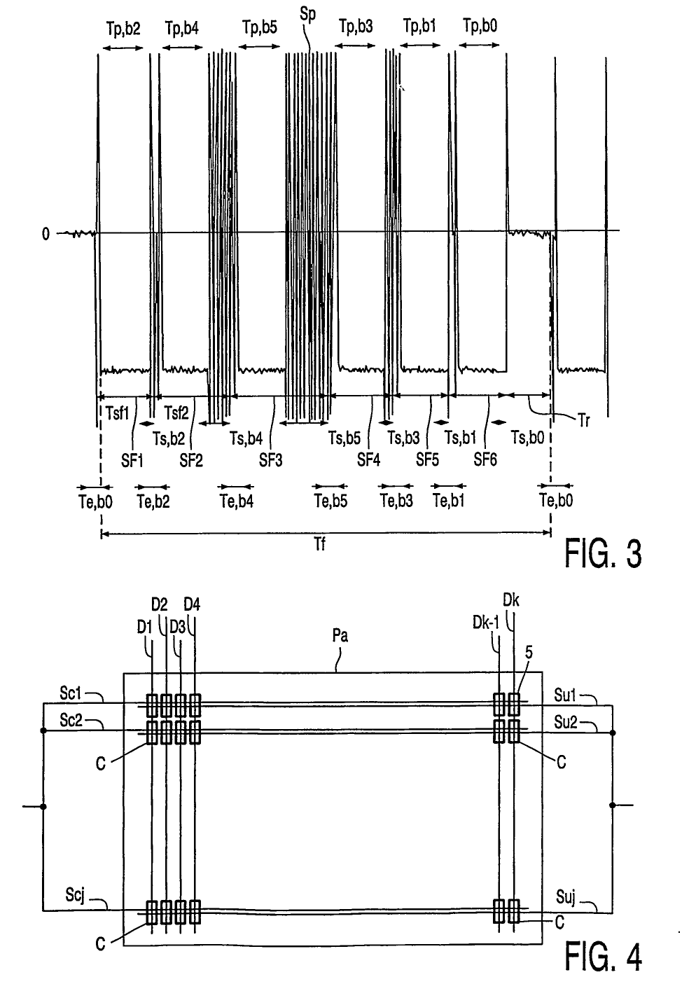

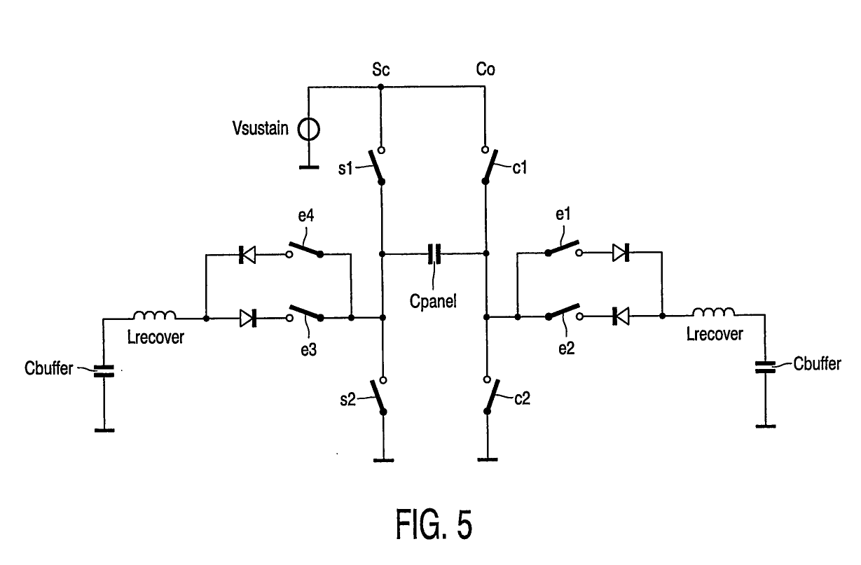

FIG. 2 schematically illustrates a circuit for driving a PDP of a surface-discharge type in a subfield mode as known from the prior art. Two glass panels (not shown) are arranged opposite to each other. Data electrodes D are arranged on one of the glass panels. Pairs of scan electrodes Sc and sustain electrodes Su are arranged on the other glass panel. The scan electrodes Sc are aligned with the sustain electrodes Su, and the pairs of scan and sustain electrodes Sc, Su are perpendicular with respect to the data electrodes D. Display elements (for example, plasma cells or pixels C) are formed at the points of intersection of the data electrodes and the pairs of scan and sustain electrodes Sc, Su. A timing generator 21 receives display information Pi to be displayed on the PDP. The timing generator 21 divides a field period Tf of the display information Pi into a predetermined number of consecutive subfield periods Tsf as shown in FIG. 3. A subfield period Tsf comprises an address period or prime period Tp and a display or sustain period Ts. During an address period Tp, a scan driver 22 supplies pulses to the scan electrodes Sc, and a data driver 23 supplies data di to the data electrodes D to write the data di to the display elements C associated with the selected scan electrode Sc. In this way the display elements C associated with the selected scan electrode Sc are preconditioned. A sustain driver 26 drives the sustain electrodes Su. During an address period Tp, the sustain driver 26 supplies a fixed potential. During a display period Ts, a sustain pulse generator 25 generates sustain pulses Sp which are supplied to the display elements C via the scan driver 22 and the sustain driver 26. The display elements, which are preconditioned during the address period Tp to produce light during the display period Ts, produce an amount of light in dependence on a number or a frequency of the sustain pulses Sp. It is also possible to supply the sustain pulses Sp to either the scan driver 22 or the sustain driver 26.

The timing generator 21 further associates a fixed order of weight factors Wf with the subfield periods Sf in every field period Tf. The sustain generator 25 is coupled to the timing generator to supply a number or a frequency of sustain pulses Sp in conformance with the weight factors Wf such that an amount of light generated by the preconditioned display element C corresponds to the weight factor Wf. A subfield data generator 24 performs an operation on the display information Pi such that the data di is in conformance with the weight factors Wf.

When regarding a complete panel, the sustain electrodes Sc are often interconnected for all rows of the PDP panel. The scan electrodes Sc are connected to row ICs and scanned during the addressing or priming phase. The column electrodes D are operated by column ICs and the plasma cells C are operated in three modes:

1. Erase mode. Before each subfield is primed, all plasma cells C are erased at the same time. This is done by first driving the plasma cells C into a conducting state and then removing all charge built up in the cells C.

2. Prime mode. Plasma cells C are conditioned such that they will be in an on or off state during the sustain mode. Since a plasma cell C can only be fully on or off, several prime phases are required to write all bits of a luminance value. Plasma cells C are selected on a row-at-a-time basis, and the voltage levels on the columns will determine the on/off condition of the cells. If a luminance value is represented in 9 bits, then also 9 subfields are defined within a field. Different examples of subfield distributions are possible.

3. Sustain mode. An alternating voltage is applied to scan and sustain electrodes Sc, Su of all rows at the same time. The column voltage is mainly at a high potential. The plasma cells or pixels C primed to be in the on state will light up. The weight of an individual luminance bit will determine the number of light pulses during the sustain period.

FIG. 3 shows voltage waveforms between scan electrodes Sc and sustain electrodes Su of a PDP. Since there are three modes, the corresponding time sequence is indicated as Te,bx (erase mode for bit-x subfield), Tp,bx (prime mode for bit-x subfield), and Ts,bx (sustain mode for bit-x subfield). The different subfields are indicated by SF1, SF2 etc. In this example there are six subfields (SF1 to SF6) within the field Tf. The subfield distribution is 4116/32/8/2/1.

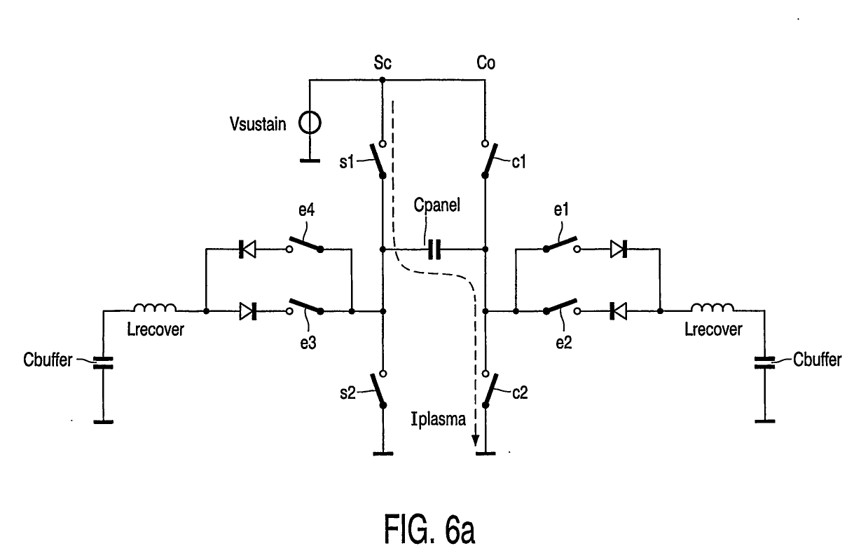

FIG. 4 further illustrates the layout of pixels C in a plasma display panel Pa. The pixels are identical in structure to the pixel shown in FIG. 1 and form a display area. The pixels are arranged in j rows and k columns, and a small box stands for each pixel in FIG. 4. Scan electrodes (Sci) and sustain electrodes (Sui) extend in the direction of the rows, and the scan electrodes are paired with the respective sustain electrodes. The pairs of scan/sustain electrodes are associated with the respective rows of pixels. Data electrodes (Di) extend in the direction of columns and are associated with the respective columns of pixels.

In energy recovery systems, energy recovery circuits are usually arranged between the scan and sustain electrodes or between each group of electrodes and buffer capacitors. As a consequence, current leads which must be capable of carrying major currents (which may be as strong as 100 A) run over the length of the device, usually along the rear side, or extra components (the buffer capacitors) are needed.

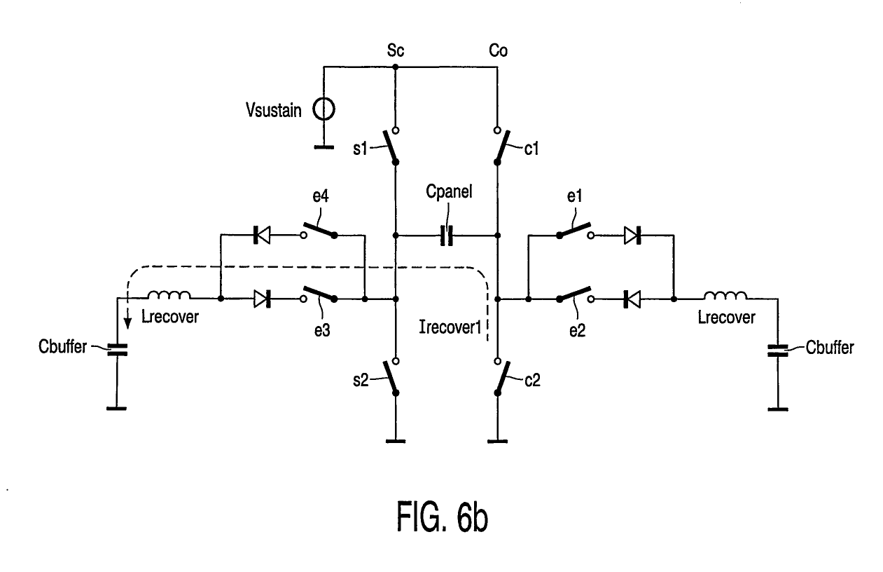

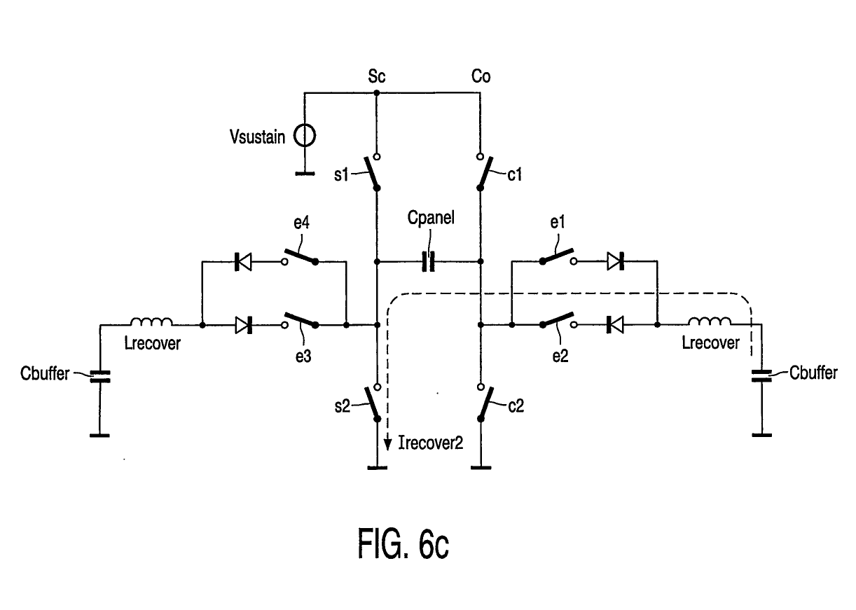

A recovery system for recovering energy during the sustain phase is schematically shown in FIGS. 5, 6a to 6e by way of example.

Because of the mainly capacitive character of a PDP (Plasma Display Panel), blind power dissipation and EMI can be strongly improved with a proper energy recovery circuit. In FIGS. 5 and 6a to 6c, an energy recovery circuit is arranged between the scanning and common ‘row electrodes’ or between a group of scanning electrodes and a group of row electrodes. In FIG. 5, the so-called Weber energy recovery topology is connected to the ‘row electrodes’ of a PDP. In FIGS. 5 and 6, the scan side of the panel is denoted by Sc, the common side by Co. In this recovery system, buffer capacitors Cbuffer are used at both sides of the panel to store energy and re-use it. The different switches are denoted s1 and s2 (for the scan side), c1 and c2 (for the common side), and e1 to e4 for the energy recovery circuits. The panel capacitance is indicated by Cpanel. FIG. 5 schematically shows the panel with energy recovery circuits at both sides of the panel. With The Weber energy recovery topology, the voltage across the panel capacitor is inverted in two steps. These steps are shown in FIGS. 6a to 6d, while FIG. 6e plots the currents and sustain voltages as a function of time, i.e. within the different periods indicated in Figs. a to d. Finally, it is indicated at the bottom of the lowest graph which switches are activated in which periods. In FIG. 6b the scan side of the panel is discharged and stored in a buffer capacitor Cbuffer. The arrow in this FIG. 6b illustrates the recovery current Irecoverl. Now the common side of the panel capacitance must be charged again, which is done in FIG. 6c. Charge is transferred from panel capacitance Cpanel to buffer capacitances Cbuffer and vice-versa. Instead of dissipating the energy during discharging, the energy is thus recovered via the buffer capacitances.

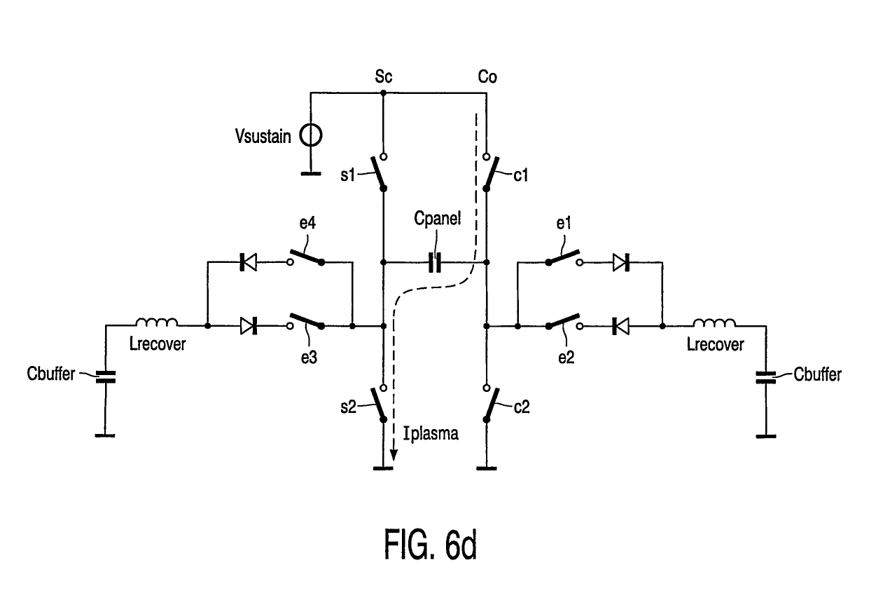

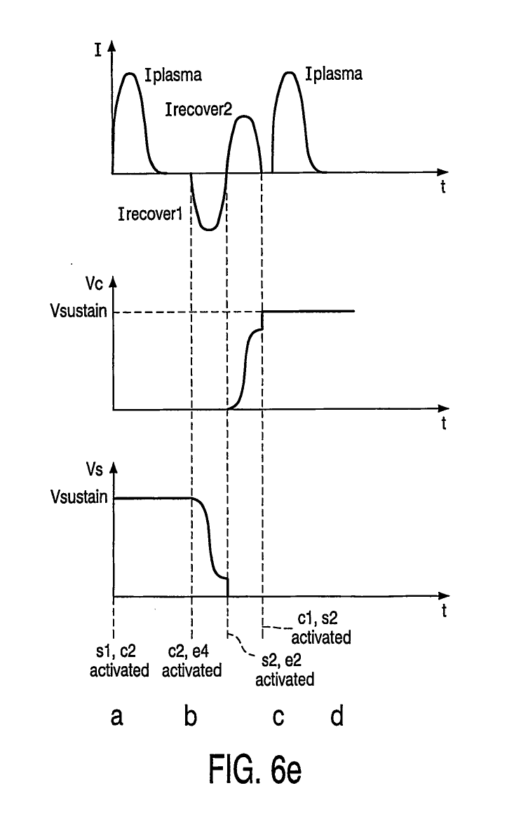

FIGS. 7 to 8d illustrate an energy recovery scheme for recovering energy in the address phase.

A large capacitive load has to be driven also in addressing the ‘column electrodes’. The idea of storing and re-using energy, as is done for the row capacitances, may also be implemented with respect to the stored energy in the column capacitances (thus improving the power dissipation and EMI). Things are a bit different, but with the resonant circuitry based on the Weber topology energy in the column capacitances will still be stored and re-used. An equivalent diagram of energy recovery for the column electrodes (in the addressing phase) of a PDP is shown in FIG. 7. The column electrodes are driven by data driver ICs. For the sake of simplicity, only one column driven by one output stage (denoted by switches sIC1 and sIC2) of a data driver IC is shown. In practice, each column can be pulled to the ‘VDH node’ (see FIG. 8) or ‘ground’ by similar sIC1 and sIC2 switches in the data driver ICs. Compared with FIG. 5, only a single energy recovery circuitry is present in this case and therefore also one buffer capacitor Cbuffer. The different switches in the circuitry are denoted sI (to supply the data driver ICs with Vaddress) and e3 and e4 for recovering energy. With this circuitry, the supply voltage ‘VDH’ for the data driver ICs is controlled in a resonant way.

A complete sequence of storing and re-using stored energy in the columns is shown in FIGS. 8a to 8c. In FIG. 8d, the currents and voltages are indicated as a function of time, i.e. within the different periods indicated in FIGS. 8a to 8c. Finally, it is indicated at the bottom of the lowest graph which switches are activated in which periods. In FIG. 8a, the supply pin (VDH) of the data driver ICs are pulled to a fixed voltage source (typically 60V) by means of switch s1. This supplies the data driver ICs with a stable voltage which is essential for proper addressing of the columns. The addressing of the correct columns for the scanned row is done by the control lines to the data driver ICs. Via the switches sIC1 and sIC2 a column is pulled to the address voltage VDH or to ground. Columns pulled to VDH are said to be addressed, and columns pulled to ground are said not to be addressed.

After the appropriate columns have been addressed, switch s1 is deactivated and the switches in the data driver ICs (sIC1 and sIC2) are set in their ‘high-impedance’ mode. Now, the columns are floating while the charge in the addressed columns remains (via the capacitive behavior of a column). With switch e4 and the parasitic diodes in parallel with switches sIC1 (FIG. 8b), an inductor Lrecover is connected in series with the column capacitances. A sine-wave current will start to flow, and the voltage across the charged columns decreases by a cosine function. The flowing current and the column voltage during ‘energy storing’ are shown next to FIG. 8b. In this circuit use is made of a half-period of the resonance phenomenon (determined by Ccolumns and Lrecover). When half a sine-wave has been completed, the current (Istore) has a zero-crossing. A diode in series with switch e4 prevents the current from going negative. At this point the voltage across the column capacitances has reached its minimum.

Simultaneously with storing energy, data corresponding to the next row to be addressed is transferred to the driver ICs. As the half sine-wave for storing energy is completed, this ‘new’ data is set to activate the appropriate sIC1 and sIC2 switches. The correct columns are connected to the VDH node thereby, and switch e3 is activated (FIG. 8c). The stored energy in the buffer capacitor of those columns where switch sIC 1 was activated, is transferred back to the panel. In the opposite direction, a sine-wave current will start to flow, and the voltage across the selected columns increases by a cosine function. This re-use of the stored energy is shown in FIG. 8d. Again when half a sine-wave is completed, the current (Ire-use) passes zero and is blocked from flowing back by the diode connected in series with switch e3. Inevitable losses are present in the resonance loop, and therefore switch s1 is activated to pull the VDH supply line for the data driver ICs to Vaddress. Now the driver ICs are supplied with a stable voltage and the appropriate columns are properly addressed. With this, one full cycle of addressing columns, storing energy, and regaining energy has been completed.

For improved operation of the circuit, quite a large buffer capacitor is preferred. If this is provided, the voltage rise and fall across the buffer capacitor (during storing and regaining energy) will be negligible and will stabilize at half the address voltage (which is typically 30V).

The invention is based on the insight that energy recovery for the column drivers is beneficial when the data on the columns changes value (from active to non-active or vice-versa, when subsequent cells in a column have to be driven), whereas it is unfavorable when the data has to remain high. PDPs are driven by the so-called subfield driving scheme to create gray levels. The invention is that the energy recovery for the column drivers is applied only to a limited number of subfields. Subfields with a low value will have a very low data correlation. Consequently, the data values will change often and energy recovery is desirable. On the other hand, subfields with a high value will have a high data correlation. Thus, the data will remain high (or low) often and energy recovery is not desirable. By using this invention, energy recovery is only applied to subfields if it is desirable. Overall, this will result in a lower power consumption and better EMI reduction. The beneficial effect of the invention is illustrated by the results of calculations. It is assumed for the calculations that interlaced addressing is used, i.e. an addressing scheme in which first the odd rows and then the even rows are addressed, whereupon the whole image is sustained. Please note that this will decrease the data correlation (because two temporal consecutive rows are spatially more widely separated). The calculations are quite simple:
First, for each column (R,G,B) and each subfield in the picture, all transitions from zero to one and one to zero (or more generally active to non-active) are counted. This is a measure for the power consumption without the use of energy recovery.
Second, for each pixel (R,G,B) and each subfield of the picture, the number of times that a small trailing edge in voltage is present is counted (see FIG. 8d, V versus t graph, in which the voltage after the Ire-use phase is slightly below the ‘normal addressing voltage; this edge accounts for the losses during the recovery loop). This number is multiplied by the loss factor during energy recovery (which is assumed to be 30%). Now, the calculated value is a measure for the power consumption when energy recovery is applied.

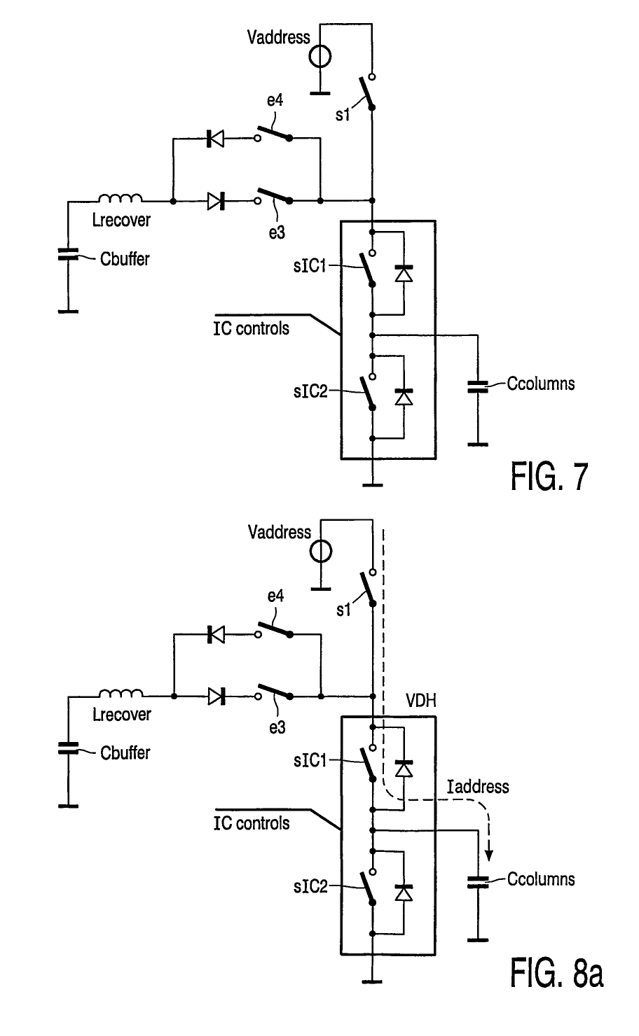

When this is done for an image with 8 binary weighted subfields (weights: 1/2/4/8/16/32/64/128), this results in a graph as shown in FIG. 9. The bold line represents the results of the calculations without energy recovery and the dotted line the results with energy recovery. This graph shows the result for video information. Clearly, there is a break-even point: using energy recovery for the low-weight subfields gives a significant reduction and energy recovery for the higher-weight subfields results in an increase in the dissipated power. According to the invention, energy recovery in the column direction should only be used for the 4 or 5 subfields with the lowest values.

Identical calculations may be performed for 16 different pictures. The results are shown in Table 1. The second column indicates the relative reduction of power consumption if energy recovery is applied to all subfields compared with the initial situation without energy recovery. The third column indicates the reduction when the invention of subfield-selective energy recovery is used, compared with the situation without energy recovery. Energy recovery for all subfields gives a 20% reduction, while the invention gives a 27% reduction in power dissipation.

TABLE 1
Results for 16 different images

| subfield | improvement | improvement by | using row- |
|---|---|---|---|
| improvement | by using | using subfield- | selective |
| distribution | ER for all subfields | selective ER | ER |
| binary subfields | +20% | +27% | +28% |
| duplicated subfields | −20% | +17% | +19% |

In the above-described calculations, binary weighted subfields are used. However, there are more possible ways of distribution of the subfields. Therefore, identical calculations are made for Duplicated Subfields (weights 12/8/4/2/1/4/8/12). This is a subfield distribution that decreases the perception of motion artifacts, and it is implemented in many commercially available panels (for example FHP). For an example of a description of a duplicated subfield addressing scheme, reference is made to ASIA Display'96, Part S-19-3, ‘Improvement of Video Image Quality in AC Plasma Display Panels by Suppressing the Unfavorable Coloration Effect with Sufficient Gray Shades Capability’ by T. Makino, A. Mochizuki et al., which is hereby incorporated by reference. The results of the calculations are also shown in Table 1, under ‘duplicated subfields’, and at first, they may seem somewhat surprising. If energy recovery is applied to all subfields, the power consumption will increase! This can be explained by the duplication of the subfields. If a duplicated subfield is turned on for a certain pixel, there is a strong probability that it will also be turned on for the next addressed row (if interlaced addressing is used). If energy recovery is now applied according to the invention, the power consumption will decrease by 17%, which is a significant improvement.

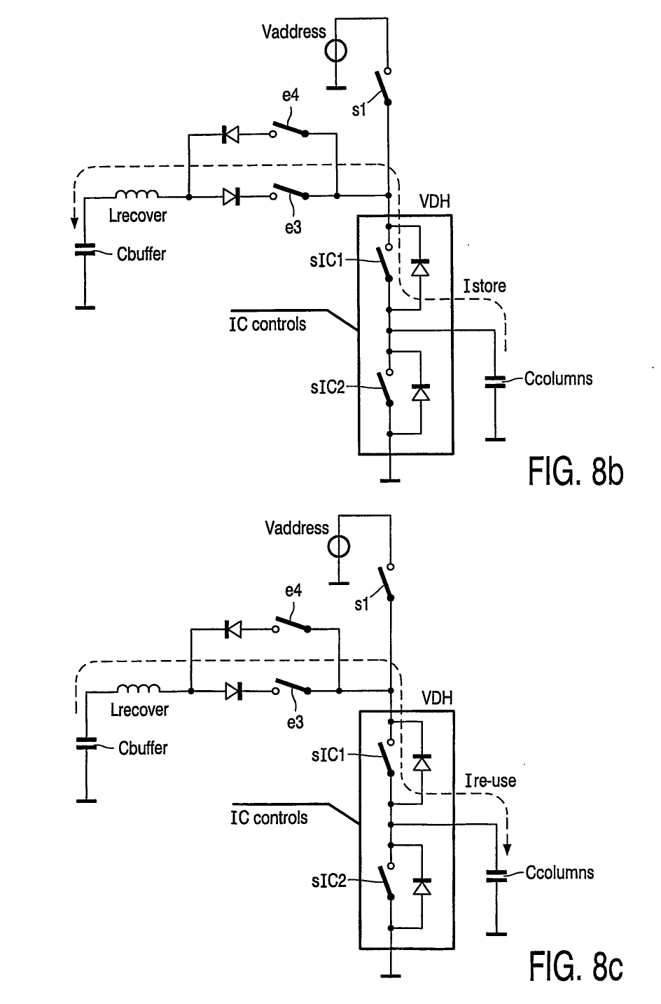

The examples so far relate to display of video information. FIG. 10 illustrates the results for data graphics (i.e., for example, black text on a white background). For such types of images the ‘break-even point’ lies at a relatively lower subfield because of the much smaller number of changes in data Preferably, energy recovery is used only for the first two subfields. Use of a discriminator may be preferred in such embodiments, where it is useful and possible to make a distinction between the type of information displayed (video or data graphics), and then the proper number of subfields is selected.

In an alternative embodiment of the invention discrimination is not applied per subfield, but per row. It must now be calculated for each row whether energy recovery is desirable or not. This can be done with the same calculations, but they are now made per row instead of per subfield. The last column in Table 1 shows the results for row-selective energy recovery. The reduction in power consumption is somewhat larger than for subfield-selective energy recovery. However, this embodiment of the invention requires a calculation which complicates the design of the apparatus, as will be shown below.

Now the only remaining question is for which subfields the energy recovery should be set active and for which it should be set inactive. A straightforward way of doing this is simply by performing the calculations as described in the previous section. However, this would have to be done for each subfield, and the total number of operations would be very large. This is also true when row-selective energy recovery is used. The total number of calculations per second equals: #rows*#dots*3 (with and without ER and a comparison)*#frames. Furthermore, a line memory is required. If a VGA display is used at 50 Hz, this will result in 480*850*3*50*3=180 million operations per second!

An alternative solution is shown in Table 2. The 3^{rd} column shows the relative reduction of power consumption when the invention is used for a fixed number of subfields. Surprisingly, the difference with the situation when the optimum number of subfields is chosen is very small. By using a fixed number of subfields, almost the entire gain can be obtained without the need for a huge number of operations per second.

TABLE 2
Results for a fixed number of subfields

| | | | # of sub- |
|---|---|---|---|
| | improvement with | improvement by | fields |
| | subfield-selective ER | using a fixed # of | that do not |
| subfield | acc. to Table Is | subfields | apply ER |
| binary subfields | +27% | +26% | 3 |
| duplicated | +17% | +17% | 6 |
| subfields | | | |

As we have seen, this fixed number of subfields that do not apply ER depends on the subfields distribution (binary weighted subfields, duplicated subfields). Furthermore, it also depends on the efficiency with which energy is recovered. Other variables that may be used are the display or subfield load. If the display load is high, it is likely that the data correlation is higher, and energy recovery should be applied to fewer subfields. These variables usually are measured by a digital board, so they can be simply re-used to control the energy recovery circuit. Finally, the last variable is the display mode. The pictures that were used in the calculations are all video images. For data graphics, the data correlation is much higher, and energy recovery will probable be beneficial for fewer subfields. All such parameters may be fed or calculated by a discriminator. However, they are relatively simple to calculate and thus do not require extensive calculating power.

Within the overall framework of the invention, the choice of the number of subfields, or the selection of the subfields for which energy recovery is activated during operation, may be different from one embodiment to the next. In a simple, yet already relatively very advantageous embodiment, the number of subfields during which the energy recovery circuit is activated is fixed, for example, the two, three, or four lowest-weight subfields. The choice of the subfields may be dependent on the way in which the data is arranged, i.e. the distribution of subfields.

In more elaborate display apparatuses, a discriminator is used which, based on the data to be displayed, calculates the advantages/disadvantages of energy recovery (or has data providing the relation between advantages/disadvantages and a certain parameter) and chooses the subfields or the number of subfields during which the energy recovery circuit is activated or deactivated. One such parameter is, as described above, the panel load. This is an easily retrievable parameter. A discriminator may be any piece of hardware and/or software capable of calculating or determining the effects and making a choice. With such a discriminator it is also possible to perform the calculation per row and to activate or deactivate the energy recovery circuit per row displayed. A discriminator can decide for which subfields energy recovery is to be activated on the basis of the nature or parameters of the image to be displayed.

How many columns are addressed for a particular row is of course dependent on the video content. The half-period of a resonant cycle is thus also dependent on the video content.
To=2π*SQRT(L_{recover}*n*C_{columns})
tₛₜₒᵣₑ=t_{regain}=TP/2=π*SQRT(L_{recover}*n*C_{columns})

In this formula, ‘n’ denotes the number of addressed columns and ‘C_{columns}’ denotes the capacitance of a single column. If all columns are (or have to be) addressed, the half period resonant time will be a maximum (n is maximum). The other extreme is that only one column is (or has to be) addressed, then the half period will be a minimum (n=1). In contrast with a varying half-period time, activating and deactivating the switches is done with fixed time intervals. It seems best to set the time intervals of the switches so as to correspond to the maximum half-period resonant time. For example, this time interval for storing (and re-using) energy may be set at 250 ns. It is important to realize that this time will be consumed for each scanned row in each subfield where energy recovery is active.

Without the use of ‘subfield-selective energy recovery for the columns’, as much as 2 ms will be consumed for recovering energy in the addressing phases.
t_{recover}n_{rows}*M_{subfields}*(tₛₜₒᵣₑ+t_{regain})
t_{recover}=480*8*500*10⁻⁹=2 msec

This extra consumed time in the addressing phases is subtracted from the sustain phases. Less sustaining time (in this example 2 ms) leads to a less bright picture and is considered to be a disadvantage.

Application of the present ‘subfield-selective energy recovery for the columns’ invention leads to less time consumed by the addressing phases. After all, energy recovery is made active for a certain amount of subfields only. It may be that energy recovery is made active for only the four lowest subfields.
t_{recover}=n_{rows}*M_{ERsubfields}*(tₛₜₒᵣₑ+t_{regain})
where m_{ERsubfields} stands for the number of subfields for which energy is recovered (in this case 4).
t_{recover}=480*4*500*10⁻⁹=1 msec
With this example, only 1 ms is subtracted from the sustain phases. With more time available in the sustain phases, a brighter picture can be displayed.

It will be clear that the invention is not restricted to the embodiment given by way of example. In all descriptions thus far, for example, the cells are in the off-state when the addressing phase begins, and all cells that should emit light are made active. The opposite is also possible. In that case, all cells are activated in the erase phase (which is then called the setup phase), and all cells that should not emit light are made inactive during the addressing phase. There is still switching between active and inactive states. Furthermore, there is still a high data correlation for the subfields with a high weight and a low data correlation for the subfields with a low weight. Therefore, the invention is applicable to both kinds of addressing schemes.

Often a distributed subfield scheme, hereinafter also called DSF-scheme, is applied to reduce motion artefacts.

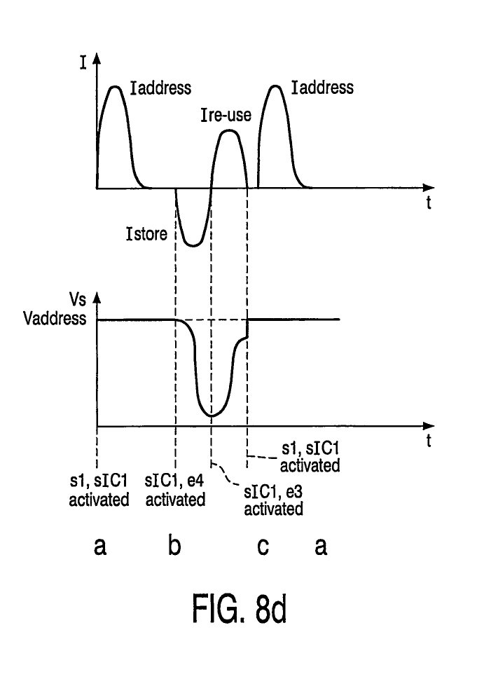

An example of such a scheme is shown in FIG. 11. The available weights of the subfields are indicated with a number above a bar. The length of the bar indicates the duration of the subfield. The positions of the bars indicate the sequence of the subframes within a frame.

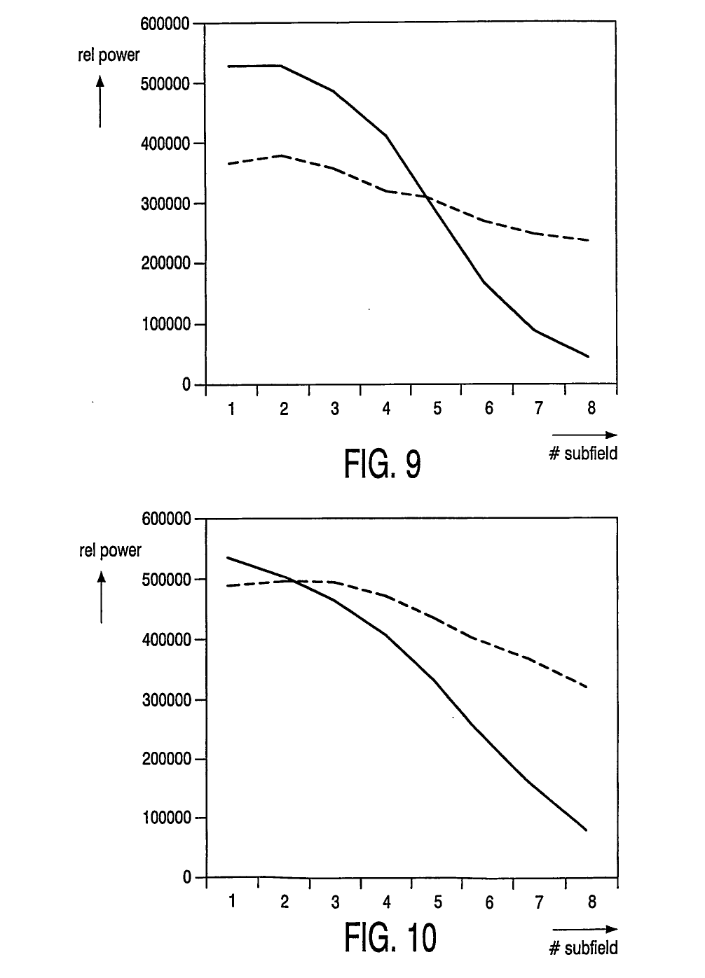

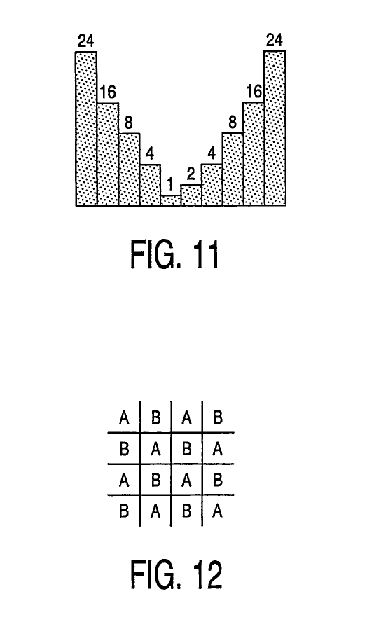

A gray level of a pixel may be obtained by different combinations of subfields. For example, using a first scheme A the gray level 8 may be obtained by using the third subfield to activate a pixel. A second scheme B may use the eights subfield to activate the pixel. By applying alternatively scheme A and B for adjacent pixels in row and column direction as shown in FIG. 12 the perception of motion artefacts is reduced. However, the result is that subsequent pixels in column direction need to be supplied with different data via the column drivers, even if the actual gray levels of these pixels are the same. By coupling a data electrode 1b in a zig-zag configuration to subsequent pixels, as shown in FIG. 13, all of the cells coupled to that data electrode 1b are supplied with the same scheme A; B. The rectangles in FIG. 12 represent pixels, the letters A or B in a pixel indicate the scheme applied to that pixel.

Summarizing, when alternating schemes A, B are used for realizing gray levels of adjacent pixels in combination with a zig-zag configuration of the data electrodes 1b, the subsequent data on the columns will have a correlation which is comparable to the correlation in the earlier described embodiment, applying straight data electrodes 1b and the same realization of gray levels for all pixels. So, despite the alternating schemes A, B energy recovery may be applied for selected sub fields, thereby showing similar benefits as demonstrated for earlier mentioned embodiments.

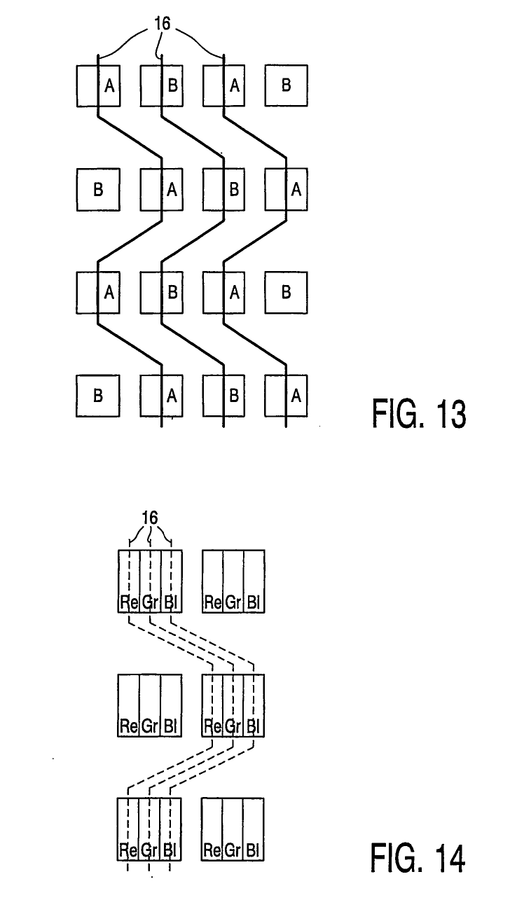

If, in an embodiment as shown in FIG. 13, each pixel comprises cells emitting different colors, then a data electrodes 1b is preferably coupled to cells, which emit substantially a same color. For example, if each pixel comprises 3 different cells Re, Gr, Bl by each emitting a different color as shown in FIG. 14, a data-electrode 1b is coupled in a zig-zag configuration, as indicated by a dotted line, to the cells Re; Gr; Bl emitting a same color.

The embodiments with zig-zag configuration of the data electrodes 1b may also be applied without an energy recovery circuit and means for activating the energy recovery circuit for a part of the total number of subfields. For example, the zig-zag configuration may also be used advantageously in combination with a PDP, which uses partial line doubling (PLD) to reduce the addressing time.

As the principles of PLD are known, they are not elaborated in detail here. In case PLD is applied, then for a part of the number of subfields line doubling is applied, which means that, for example, two subsequent lines are displayed using for a second line the same data for a part of the subfields (usually the ones with a lower weight) as the data for a first line preceding the second line.

However, combining PLD with a DSF-scheme, as, for example, shown in FIG. 12, is not directly possible. The DSF-scheme requires different gray level schemes for subsequent pixels in a column, whereas PLD requires duplication of the schemes, at least for a part of the number of subfields.

However, when applying the zig-zag configuration of, for example, FIG. 13, PDL may be applied while maintaining the alternating schemes A, B.

In this case a pixel of the second line receives data for a part of the subfields with a lower weight from a pixel in the first line adjacent to the pixel in the first line located above the pixel of the second line.

In short the invention can be described as follows.

In a flat-panel display apparatus comprising plasma discharge cells having sustain electrodes and scan electrodes, a drive circuit having a circuit for providing data to the discharge cells incorporating an energy recovery circuit and means for activating the energy recovery circuit is provided. The data supplied to the discharge cells is arranged in subfields, and the means for activating the energy recovery circuit activate the energy recovery circuit only for a part of the total number of subfields.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. Flat panel display apparatus comprising plasma discharge cells having sustain electrodes (2c) and scan electrodes (2b); and a drive circuit having a circuit for providing data arranged in subfields to the discharge cells, the drive circuit incorporating an energy recovery circuit, and means for activating the energy recovery circuit only for a part of the total number of subfields.

2. Flat panel display apparatus according to claim 1, wherein said part of the number of subfields has on average a lower weight than the rest of the sub-fields.

3. Flat panel display apparatus as claimed in claim 2, wherein the part of the subfields all have a lower weight or an equal weight compared to the subfields for which in operation the energy recovery circuit is not activated.

4. Flat panel display apparatus according to claim 1, wherein data electrodes (1b) are present being positioned in a zigzag configuration.

5. Flat panel display apparatus according to claim 1, wherein rows and columns of pixels are present, each pixel comprising at least one discharge cell, a data electrode (1b) in a column direction being alternately coupled in subsequent rows to a cell of a pixel in a first column and to a cell of a pixel in a column adjacent to the first column.

6. Flat panel display apparatus according to claim 5, wherein the data electrode (1b) is coupled to cells, which emit substantially a same color.

7. Flat panel display apparatus according to claim 1, wherein the display apparatus comprises a discriminator having means for choosing the part of the subfields during which the energy recovery circuit is activated on the basis of the data to be displayed.

8. Flat panel display apparatus according to claim 7, wherein the discriminator in operation discriminates depending on the display- and/or subfield-load.

9. Flat panel display apparatus according to claim 1, wherein the number of subfields in which energy recovery is applied is fixed.

10. Method of displaying images on a flat-panel display apparatus comprising plasma discharge cells having sustain electrodes and scan electrodes; a drive circuit having a circuit for providing data arranged in subfields to the discharge cells; and an energy recovery circuit, the method comprising the step of activating the energy recovery circuit only for a part of the total number of subfields.
